(19) United States
(12) Patent Application Publication
(10) Pub. No.: US 2026/0109894 A1
(43) Pub. Date: Apr. 23, 2026

(54) THERMAL GREASE COMPOSITION

(71) Applicant: Dow Silicones Corporation, Midland, MI (US)

(72) Inventors: Zhanjie Li, Midland, MI (US); Dan Zhao, Midland, MI (US); Devin M. Ferguson, Midland, MI (US); Eric Joffre, Shepherd, MI (US); Bizhong Zhu, Midland, MI (US); Cassandra Hale, Bay City, MI (US)

(21) Appl. No.: 19/159,649

(22) PCT Filed: Feb. 19, 2024
(86) PCT No.: PCT/US2024/016356

§ 371 Date: Aug. 26, 2025

Related U.S. Application Data
(60) Provisional application No. 63/448,880, filed on Feb. 28, 2023.

(51) Int. Cl. C09K 5/14

(52) U.S. Cl. CPC C09K 5/14

(57) ABSTRACT

The present invention relates to a composition comprising one or more filler particles and a first treating agent of Formula 1; and a second treating agent of Formula 2; where R, R¹, R², R³, Y, x, y, and z are defined herein. The composition of the present invention is useful as a non-curable thermal grease that can achieve high thermal conductivities at dispensable and processable viscosities.

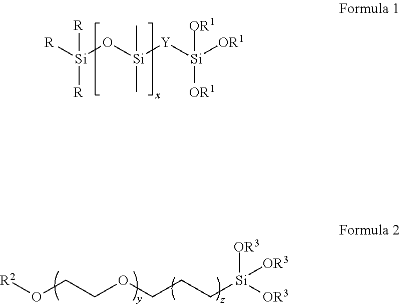

### BACKGROUND OF THE INVENTION

The present invention relates to a non-curable thermal grease composition comprising an ether-functionalized trialkoxysilane.

Non-curable thermal greases are widely used as thermal interface materials to transfer heat from a heat-generating electronic component to a heat sink. Useful thermal greases are characterized by high bulk thermal conductivity, low thermal resistance, low bondline thickness, good flowability and reworkability. More than 90 wt % of the components that constitute a thermal grease are a combination of thermally conductive fillers such as zinc oxide, alumina, aluminum, boron nitride, and aluminum nitride dispersed in a silicone-based fluid. The rapid increase of power and power density of electronic components results in greater heat generation, thereby requiring higher thermal conductivity for the thermal greases.

Thermal conductivity can be increased by increasing the loading of the thermal conductive fillers used in the preparation of the thermal grease. Unfortunately, however, higher filler loadings cause higher thermal grease viscosity, which diminishes key properties such as printability and workability. To address this problem, US 2008/0213578 A1 (Endo) discloses a thermal grease composition that includes, inter alia, a trialkylsilyl-trialkoxysilyl-terminated polysiloxane (Component B, para [0034]) and an alkoxysilane (Component C, para [0035]); the inclusion of Component C provides a composition with lower viscosity, therefore, improved thermal grease flowability as compared to a grease that does not contain this component.

Still, there is a need to achieve even lower thermal grease viscosities; accordingly, it would be an advantage in the art of non-curable thermal greases to discover a thermal grease that can achieve higher thermal conductivities without a concomitant increase in viscosity.

### SUMMARY OF THE INVENTION

The present invention addresses a need in the art of non-curable thermal greases by providing, a composition comprising, based on the weight of the composition, a) from 80 to 95 weight percent of one or more filler particles selected from the group consisting of aluminum, alumina, silicon, silicon dioxide, magnesium oxide, aluminum nitride, graphite, silicon carbide, and zinc oxide; b) 0.2 to 10 weight percent of a first treating agent of Formula 1:

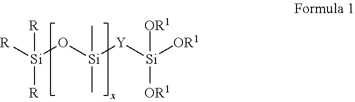

where R and R¹ are each independently C₁-C₆-alkyl; Y is O or CH₂—CH₂; x is from 20 to 200;
c) from 0.05 to 2 weight percent of a second treating agent of Formula 2:

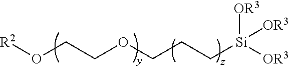

where R² is C₁-C₁₀-alkyl; each R³ is independently C₁-C₆-alkyl; y is from 0 to 8; and z is from 1 to 10; and
d) up to 8 weight percent boron nitride platelet particles.

The composition of the present invention is useful as a non-curable thermal grease.

### DETAILED DESCRIPTION OF THE INVENTION

The present invention is a composition comprising, based on the weight of the composition, a) from 80 to 95 weight percent of one or more filler particles selected from the group consisting of aluminum, alumina, silicon, silicon dioxide, magnesium oxide, aluminum nitride, silicon carbide, graphite, and zinc oxide; b) 0.2 to 10 weight percent of a first treating agent of Formula 1:

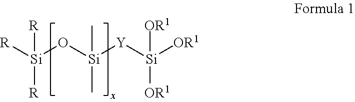

where R and R¹ are each independently C₁-C₆-alkyl; Y is O or CH₂—CH₂; x is from 20 to 200;
c) from 0.05 to 2 weight percent of a second treating agent of Formula 2:

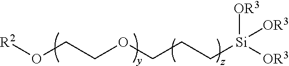

where R² is C₁-C₁₀-alkyl; each R³ is independently C₁-C₆-alkyl; y is from 0 to 8; and z is from 1 to 10; and
d) up to 8 weight percent boron nitride platelet particles.

The composition preferably comprises aluminum and zinc oxide filler particles at a combined concentration in the range of from 85 or from 90 weight percent to 95 weight percent, based on the weight of the composition. The concentration of aluminum particles is preferably in the range of from 65 or from 68 or from 70 weight percent, to 80 or to 78 or to 75 weight percent of the composition. The aluminum particles are advantageously a bimodal distribution of a) smaller particles having a D₅₀ volume average particle size in the range of from 0.5 μm or from 1 μm, to 5 μm or to 3 μm and b) larger particles having a D₅₀ volume average particle size in the range of from 7 μm to 20 μm or to 15 μm or to 12 μm.

The concentration of the ZnO particles is preferably in the range of from 10 or from 15 weight percent, to 25 or to 20 weight percent, based on the weight of the composition. The ZnO particles preferably have a D₅₀ volume average particle size in the range of from 50 nm or from 80 nm, to 500 nm or to 200 nm or to 150 nm. D₅₀ and D₉₉ volume average particle sizes for aluminum, zinc oxide, and alumina particles refer to D₅₀ volume average particle diameter as measured using laser refractometry.

The concentration of the first treating agent of Formula 1 is in the range of from 0.2 or from 1 or from 3 weight percent, to 8 weight percent, based on the weight of the composition. R and R¹ are each preferably methyl, more preferably methyl; x is in the range of from 20 to 200 or to 150 or to 100 or to 50.

The concentration of the second treating agent of Formula 2 is in the range of from 0.05 or from 0.1 weight percent, to 2 or to 1 or to 0.5 weight percent, based on the weight of the composition. Preferably, R² and R³ are each independently ethyl or methyl, more preferably methyl; y is from 0 to 8 or to 6 or to 5; and z is from 1 to 10 or to 8 or to 6.

The composition optionally comprises boron nitride platelet particles, which increase thermal conductivity at the expense of viscosity. The platelet particles have a thickness, as measured by Scanning Electron Microscopy (SEM), preferably in the range of from 750 nm to 5 μm, and a D₅₀ particle size diameter, as measured by dynamic light scattering, preferably in the range of from 3 μm to 40 μm. The diameter-thickness aspect ratio of the boron nitride platelet particles is preferably in the range of from 2:1 or from 3:1 or from 4:1, to 50:1 or to 30:1 or to 20:1 or to 10:1. The boron nitride platelet particles have a hexagonal crystal structure. During assembly the boron nitride platelet particles align approximately along the same direction as the substrates after the platelet particles are applied between the substrates. As such, the D₅₀ particle size of the boron nitride platelet particles does not influence the final bondline thickness. Commercially available examples of boron nitride platelet particles include CarboTherm PCTP30 Boron Nitride from St. Gobain and PolarTherm PT110 from Momentive Performance Materials. The concentration of boron nitride platelet particles is in the range of from 0 or from 0.5 or from 1 or from 2 weight percent, to 8 or to 6 or to 5 or to 4 weight percent, based on the weight of the composition.

The composition of the present invention provides a non-curable grease that can achieve high thermal conductivities at dispensable and processable viscosities.

### EXAMPLES

In each of the following examples, pbw refers to parts by weight. All mixing was carried out using a Flacktek Speedmixer at 1500 rpm unless otherwise noted.

### General Procedure for the Preparation of a Thermal Conductive Material

A first filler treating agent of Formula 1 (TA1, 6.01 pbw, each R and R¹═CH₃; R═O; and x=30, prepared as described in US Pat. Pub. 2006/0100336), a second filler treating agent (TA-2 to TA-6, 0.2 pbw), Zoco 102 ZnO particles (ZnO-1, 11.76 pbw, 0.12 μm); and Zoco 104 ZnO particles (ZnO-2, 5.88 pbw, 0.20 μm) were added to a MAX100 cup and mixed for 15 s. First aluminum particles (Al-1, 24.38 pbw, 2.0 μm, equivalent to TCP-2 Al powder) were then added to the mixer and the contents were mixed for 15 s. TCP-9 Al powder (Al-2, 48.77 pbw, 9.9 μm) was then added to the mixer and mixing was continued for 40 s. The mixture was then hand-mixed with a spatula then further mixed in the mixer for 40 s. Boron nitride (BN, 3 pbw) was then added to the mixer and mixing was continued for 15 s. The formulated composition was transferred to an aluminum pan and heated at 150° C. in vacuo (23 Torr) for 1 h.

Table 1 summarizes the materials and amounts used to prepare the examples and the comparative examples. TA-2, TA-3, TA-4, TA-5, and TA-6 have the following structures:

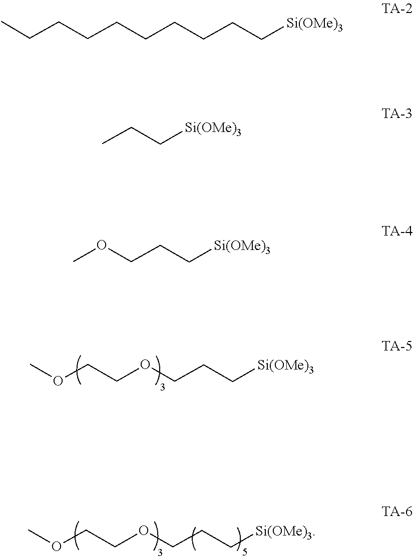

TABLE 1
Thermal Grease Compositions

| Material | Comp. 1 (g) | Comp. 2 (g) | Ex. 1 (g) | Ex. 2 (g) | Ex. 3 (g) |
|---|---|---|---|---|---|
| Al-1 | 24.38 | 24.38 | 24.38 | 24.38 | 24.38 |
| Al-2 | 48.77 | 48.77 | 48.77 | 48.77 | 48.77 |
| ZnO-1 | 11.76 | 11.76 | 11.76 | 11.76 | 11.76 |
| ZnO-2 | 5.88 | 5.88 | 5.88 | 5.88 | 5.88 |
| BN | 3.00 | 3.00 | 3.00 | 3.00 | 3.00 |
| TA-1 | 6.01 | 6.01 | 6.01 | 6.01 | 6.01 |
| TA-2 | 0.20 | — | — | — | — |
| TA-3 | — | 0.20 | — | — | — |
| TA-4 | — | — | 0.20 | — | — |
| TA-5 | — | — | — | 0.20 | — |
| TA-6 | — | — | — | — | 0.20 |

### Viscosity Measurement

Complex viscosity at the dilatant point (Pa·s) was measured by ASTM D4440-15 (Standard Test Method for Plastics: Dynamic Mechanical Properties Melt Rheology) using instrument model ARES-G2 by TA Instruments equipped with 25-mm parallel plates (serrated steel). Testing conditions were based on strain sweep conducted at 25° C. with a gap of 2.0 mm. The measurements were taken using the standard procedure of 10 rad/s oscillation frequency, sweeping from 0.01 to 200% strain amplitude with 20 sampling points per decade. The dilatant point was defined as the strain at which the complex viscosity starts increasing.

Table 2 summarizes the viscosity at dilatant point (Viscosity) for the samples in Pa·s.

TABLE 2
Viscosity at Dilatant Point for the Samples

| Example No. | Second Filler Treating Agent | Viscosity (Pa · s) |
|---|---|---|
| Comp. Ex. 1 | TA-2 | 89 |
| Comp. Ex. 2 | TA-3 | 106 |
| Ex. 1 | TA-4 | 53 |
| Ex. 2 | TA-5 | 23 |
| Ex. 3 | TA-6 | 40 |

The data show a marked lowering in viscosities for samples prepared with ether-functionalized trimethoxylsilane filler treating agents versus samples prepared using alkyl trimethoxysilanes. Lower viscosity formulations provide a pathway for the formulator to optimize viscosity and thermal conductivity. For example, when the formulation of Example 2 was modified to increase the BN concentration to 5 pbw and reduce the Al-2 concentration to 46.77 pbw, the thermal conductivity was measured to be 7.9 W/m. K, and the viscosity was found to increase to 68 Pa·s. In contrast, the thermal conductivity for Comparative Example 1 was measured to be 7.9 W/m·K, but at a viscosity of 89 Pa·s.

1. A composition comprising, based on the weight of the composition, a) from 80 to 95 weight percent of one or more filler particles selected from the group consisting of aluminum, alumina, silicon, silicon dioxide, magnesium oxide, aluminum nitride, silicon carbide, graphite, and zinc oxide; b) 0.2 to 10 weight percent of a first treating agent of Formula 1: 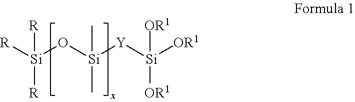
where R and R¹ are each independently C₁-C₆-alkyl; Y is O or CH₂—CH₂; x is from 20 to 200;
c) from 0.05 to 2 weight percent of a second treating agent of Formula 2: 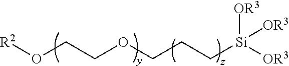
where R² is C₁-C₁₀-alkyl; each R³ is independently C₁-C₆-alkyl; y is from 0 to 8; and z is from 1 to 10; and
d) up to 8 weight percent boron nitride platelet particles.

2. The composition of claim 1 wherein the filler particles selected from the group consisting of aluminum, alumina, and zinc oxide.

3. The composition of claim 2 which comprises a) aluminum and zinc oxide filler particles at a combined concentration in the range of from 85 to 95 weight percent, based on the weight of the composition, and b) boron nitride platelet particles at a concentration in the range of from 0.5 to 8 weight percent, based on the weight of the composition.

4. The composition of claim 3 wherein Y is O; x is from 20 to 100; y is from 0 to 6; z is from 1 to 8; and R, R¹, R², and R³ are each methyl.

5. The composition of claim 2 wherein the concentration of the first treating agent of Formula 1 is in the range of from 1 to 8 weight percent, based on the weight of the composition; and the concentration of the second treating agent of Formula 2 is in the range of from 0.1 to 1 weight percent, based on the weight of the composition.

6. The composition of claim 3 wherein the concentration of aluminum particles is in the range of from 65 to 80 weight percent, based on the weight of the composition; and the concentration of the zinc oxide particles is in the range of from 10 to 25 weight percent, based on the weight of the composition; wherein the aluminum particles are a bimodal distribution of a) smaller particles having a D₅₀ volume average particle size in the range of from 0.5 μm to 5 μm; and b) larger particles having a D₅₀ volume average particle size in the range of from 7 μm to 20 μm; and wherein the zinc oxide particles have a D₅₀ volume average particle size in the range of from 50 nm to 200 nm.

7. The composition of claim 5 wherein the concentration of aluminum particles is in the range of from 70 to 78 weight percent, based on the weight of the composition; and the concentration of the zinc oxide particles is in the range of from 15 to 20 weight percent, based on the weight of the composition; wherein the aluminum particles are a bimodal distribution of a) smaller particles having a D₅₀ volume average particle size in the range of from 1 μm to 3 μm; and b) larger particles having a D₅₀ volume average particle size in the range of from 7 μm to 15 μm; and wherein the zinc oxide particles have a D₅₀ volume average particle size in the range of from 80 nm to 150 nm; wherein the concentration of the first treating agent of Formula 1 is in the range of from 3 to 8 weight percent; wherein x is in the range of from 20 to 50.

8. The composition of claim 7 wherein second treating agent of Formula 2 is selected from the group consisting of: 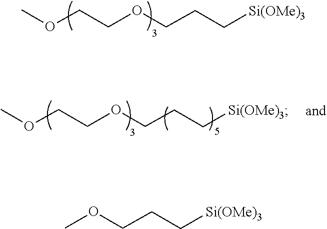
and the concentration of the second treating agent of Formula 2 is in the range of from 0.1 to 0.5 weight percent, based on the weight of the composition.
